(19) United States
(12) Patent Application Publication
(10) Pub. No.: US 2013/0198630 A1
(43) Pub. Date: Aug. 1, 2013

(54) ASSISTED HEARING DEVICE

(71) Applicants: Clifford F. Lake, JR., Wayzata, MN (US); Jim Walters, Shorewood, MN (US)

(72) Inventors: Clifford F. Lake, JR., Wayzata, MN (US); Jim Walters, Shorewood, MN (US)

(73) Assignee: ABILITY APPS, LLC., Wayzata, MN (US)

(21) Appl. No.: 13/449,527

(22) Filed: Apr. 18, 2012

Related U.S. Application Data
(60) Provisional application No. 61/592,210, filed on Jan. 30, 2012.

(51) Int. Cl. G06F 3/01

(52) U.S. Cl. 715/716

(57) ABSTRACT

An audio processing device including multiple input receivers to receive input signals from multiple sources and a user interface that facilitates selection of audio source and associated parameters, amplification and processing of the chosen source or sources and an audio output, operably coupled to wired or wireless earphone, headset, or headphone to the end user. The enhanced user interface provided by a smartphone, or tablet device or other interface the user can choose one or more audio sources to be heard and enhanced with additional content or audio sources from a network or other secondary signal source.

### RELATED APPLICATION

This application claims the benefit of U.S. Provisional Application No. 61/592,210 entitled “Assisted Hearing Device” filed Jan. 30, 2012, which is incorporated herein in its entirety by reference.

### FIELD OF THE INVENTION

The invention relates to a methods and apparatus for processing audio data and converting audio data into a format suitable for consumption by an end user. More particularly, the invention relates to processing audio data in such a way that the understandability of the audio data is increased for the end user.

### BACKGROUND OF THE INVENTION

Assisted Listening Devices (ALDs) are commonly used in public venues and private performances to provide end users who are in need of some type of assistance in hearing the performance or presentation material. Often, these devices are provided by the venue or organization that is hosting the event or performance, and are intended to be a general purpose solution for the widest number of users. Because the device is provided by the venue, the device is often designed to be obtrusive so that the users are less likely to inadvertently leave the venue without returning the device.

Current Assisted Listening Devices often use one of several standardized transmission formats to convey the audio information to the listening device from a central broadcast system that is connected to the audio amplification system at the venue. These standardized transmission formats may include low power FM broadcasts, infrared encoded broadcasts, inductive loop broadcasts, and network audio streams. Currently available systems generally provide access to a single transmission type, and simply amplify the audio information so that the end user can hear a louder amplified version of what others in the audience are hearing. Typically, the only adjustment available to the end user of current ALDs is volume. ALDs may also be used at home for listening to TV programs or music. These devices may connect directly to the source of audio material or be placed near the sound source and use a local microphone to provide an amplified version of the source audio material.

Current basic hearing aids receive audio input through a self-contained microphone. The audio source material received by the microphone is then is then amplified and processed for the user. Many basic hearing aids can be pre-programmed to allow for specific hearing loss parameters. The only adjustment accessible to the user is volume.

Current better hearing aids provide an audiologist with the ability to preset the audio interface within the physical hearing aid prior to actual use. The end user then has the ability to adjust the volume and, in some models, to select from several different preset audio processing configurations that may be customized by the audiologist. Some newer digital hearing aids allow an audiologist to make more preset audio configurations available within the device itself, and to enable additional sources such as a Bluetooth radio connection or a T-coil. In many cases an audiologist may customize the processing parameters based on the audio source material, but the user has relatively little control over the personal audio configuration parameters.

Most hearing aids generally provide amplification of ambient sounds but can be indiscriminate in the sounds they amplify. This can lead to an overwhelming experience for the hearing aid user as all ambient sounds (including background noise) are heard at amplified volume levels. Many hearing aid users turn their hearing aids off or take them out of their ear(s) in crowded or noisy environments. In a room that is acoustically “bright”, mid and high-frequency sounds which are pleasant to an individual with normal hearing may be overwhelming to a hearing aid user.

Hearing aid manufacturers have tried to incorporate multiple features into hearing aids to assist the user in these circumstances, but features that can be included are limited by the small volume of the hearing aid packaging. Due to the small size of the hearing aid and complexity of the necessary audio adjustment process, many of the adjustments to a hearing aid require a professional audiologist. Thus, hearing aid users are limited in their capabilities to adapt to acoustically difficult environments. Also, the professional adjustments required in combination with the expense of the actual devices put hearing aids out of reach of many people who are hard of hearing and would truly benefit from them.

Current audio processing workstations used in music production can use standardized digital signal processing algorithms to reduce background noise, eliminate unwanted impulse noise, enhance and amplify frequency bands, and perform many other modifications of the audio information to improve clarity and increase fidelity of the desired information. Audiologists are able to choose from some of these kinds of general purpose algorithms when they choose the programming for hearing aids, but they must choose algorithms that are designed to work in the widest variety of circumstances that the hearing aid wearer may be faced with, which often means that the programs are good for general use, but lacking when certain specialized situations arise for the user.

### SUMMARY OF THE INVENTION

Simple amplification in an ALD or the minimal audio adjustment scenario provided by a hearing aid is insufficient to provide all hearing impaired persons an understandable audio output. The inventors have observed that many hearing impaired persons would benefit from additional broad digital signal processing of an audio signal beyond simple amplification or minimal preset adjustment to provide them with an audio stream that is more comprehensible. Often the needs of one hearing impaired person are very different from another hearing impaired person. Thus, there is a benefit to having customizable processing that is adapted to and adjustable by the individual based on their particular impairment, needs, and the environment in which they are currently operating.

The present invention includes a device that can provide access to multiple different types of standardized ALD transmissions in such a way as to be integrated with low cost commodity technologies and customized for a particular end user's hearing needs while providing unobtrusive listening assistance.

The present invention includes methods and apparatuses for processing audio data and selecting processing parameters in such a fashion that the fidelity and understandability is maximized for the end user listening through a headset or headphones. Digital signal processing according to an embodiment of the invention may include, for example, specific frequency band enhancement, multiple frequency band enhancement, impulse noise reduction, background noise reduction, pitch modification, echo reduction, and other digital enhancement techniques.

Digital signal processing can be adjusted and controlled by an interface presented to the user on a smartphone or tablet device. Thus, the user can control and adjust processing of signals that are then sent to the headset for his or her own needs as well as to compensate for the acoustic environment in which he/she is operating.

The present invention incorporates a device to pick up all of the varying signals sent in standardized transmission formats as well as a microphone or audio transducer input. The microphone or transducer may be a part of the device or external to the device. The present invention can be implemented as an additional device to be coupled to a smartphone or tablet device which then supports control and implementation of the device or a device to be included in the physical structure of a smartphone or tablet device, which then can be used to provide an audio output which is operably coupled to a headset, earpiece, or a Bluetooth receiver to provide audio output to the hearing impaired individual using the device. The audio stream is processed in the device that is coupled to or incorporated in the smartphone or tablet device based on inputs from the various signals that are received and the chosen processing parameters. The audio inputs may be combined or mixed and/or digitally signal processed prior to sending to the headset, earpiece, earphones, or Bluetooth receiver as a simple audio stream. According to an embodiment of the invention, the smartphone or tablet device presents a user interface to control the separate device portion (if it is separate) and controls the built-in device if it is incorporated into the smartphone or tablet device. Thus the processing power of the smartphone or tablet device may be used to perform the desired processing tasks while the headset, earpiece, earphone, or Bluetooth receiver is able to receive a simple audio stream that has already undergone processing and convert the stream to acoustic signals that are heard by the user.

According to an embodiment of the present invention, a multi-service receiver is configurable based on an interface application that can be placed on the cell phone, smartphone, or tablet device. The multi service receiver may include a device or software implemented function that permits searching for the various assisted listening device signals that may be available for an event or a presentation including low power FM radio, infrared and other commonly used carrier signal formats discussed above.

According to one embodiment of the present invention, ear bud type hardwired headphones are coupled to the smartphone or tablet device and are configured to function as an antenna for the reception of radio signals.

According to another embodiment of the present invention, software in the form of a smartphone or tablet application is combined with an incorporated low band FM receiver as well as T-coil reception in a cell phone or smartphone to facilitate the use of assisted listening device signals by hearing impaired individuals.

This provides an ability for a user to put the cell phone, smartphone, or tablet device, for example, on a table where an event is going on and for the invention to provide an audio signal output to the hearing impaired individual that includes audio output received from the assisted listening device signal present in the forum attended as well as to combine signals from an audio transducer or a microphone either associated with the cell phone or incorporated in a lapel microphone and to provide these audio output signals in a compensatable fashion to the hearing impaired individual in the form of an output signal that can be heard by a headset operably coupled to the smartphone or tablet device. This allows the user to better hear the forum received audio signal and to participate in conversation with others seated at the table.

According to an embodiment of the present invention, this functionality is incorporated into a smartphone or tablet device owned and controlled by the hearing impaired individual using it who then can customize the inputs and outputs to give them the maximum benefit from the combination of captured audio signals and assisted listening device signals that might be present in the forum.

One example embodiment combines a user provided smart phone, tablet device, or media playback device used with the present invention wherein the invention is incorporated as a feature in the smartphone. Another example embodiment integrates or operably couples the present invention with a smartphone, notebook computer, tablet device, or media playback device. Both embodiments allow for full selection of all parameters related to the improvement in sound quality and understandability for the end user. The present invention allows for the selection of one or more audio stream transmissions present in the local environment including but not limited to a low power FM broadcast transmission, an infrared encoded audio broadcast transmission, a local network audio stream transmission, and/or an inductive loop broadcast transmission, as well as providing enhanced local audio information via electronic microphone.

According to one example embodiment, the digital processing system includes a low power FM receiver, a processor, system memory, a radio transceiver for connection to an external smartphone, tablet device, and/or digital headset, and a local headphone connection.

According to another example embodiment, the digital processing system includes an infrared receiver, a processor, system memory, a radio transceiver for connection to an external smartphone, tablet device, and/or digital headset, and a local headphone connection.

According to another example embodiment, a digital processing system includes an inductive loop receiver, a processor, system memory, the radio transceiver for connection to an external smartphone, tablet device, and/or digital headset, and a local headphone connection.

According to another example embodiment, the digital processing system includes: a digital radio transceiver, a processor, system memory, a radio transceiver for connection to an external smartphone, tablet device, and/or digital headset, and a local headphone connection.

According to another example embodiment, the digital processing system includes: a digital network radio transceiver, a processor, system memory, a radio transceiver for connection to an external smartphone, tablet device, and/or digital headset, and a local headphone connection.

According to another example embodiment, the digital processing system includes an audio transducer or microphone, a processor, system memory, a radio transceiver for connection to an external smartphone, tablet device, and/or digital headset, and a local headphone connection.

According to another example embodiment, the digital processing system includes a low power FM receiver, an optional infrared receiver, an optional inductive loop receiver, an optional digital radio transceiver, an optional digital network content source, an optional audio transducer or microphone, a processor, system memory, a radio transceiver for connection to an external smartphone, tablet device, and/or digital headset, and a local headphone connection.

According to another example embodiment, the digital processing system includes an inductive loop receiver, an optional low power FM receiver, an optional infrared receiver, an optional digital radio transceiver, an optional digital network content source, an optional audio transducer or microphone, a processor, system memory, a radio transceiver that is in operable connection with an external smartphone, tablet device, and/or digital headset, and a local headphone connection.

According to another example embodiment, the digital processing system includes an inductive loop receiver, a low power FM receiver, an optional infrared receiver, an optional digital radio transceiver, an optional digital network content source, a processor, system memory, a radio transceiver that is in operable connection with an external smartphone, tablet device, and/or digital headset, and a local headphone connection.

According to another example embodiment, the digital processing system includes an inductive loop receiver, a low power FM receiver, an optional infrared receiver, an optional digital radio transceiver, an optional audio transducer or microphone, a digital network content source, a processor, system memory, a radio transceiver that is in operable connection with an external smartphone, tablet device, and/or digital headset, and a local headphone connection.

According to another example embodiment, the digital processing system includes an inductive loop receiver, a low power FM receiver, an optional infrared receiver, a digital radio transceiver, a digital network content source, an optional audio transducer or microphone, a processor, system memory, a radio transceiver for connection to an external smartphone, tablet device, and/or digital headset, and a local headphone connection.

According to another example embodiment, the digital processing system includes an inductive loop receiver, a low power FM receiver, an infrared receiver, a digital radio transceiver, a digital network content source, an optional audio transducer or microphone, a processor, system memory, a radio transceiver that is in operable connection with an external smartphone, tablet device, and/or digital headset, and a local headphone connection.

According to another example embodiment, the processing system discussed above includes a user selected smartphone, tablet device, or media playback device providing a human interface for modification and viewing of system parameters available for improved understandability of an audio stream. The adjustable parameters control the digital signal processing algorithm(s), select input source(s), adjust frequency parameters, turn features on or off, or provide other adjustments that enable increased fidelity and understandability or reduced user discomfort.

According to another example embodiment, the processing system including one of the devices from above is integrated with a manufacturer included smartphone, tablet device, or media playback device providing a human interface for modification and viewing of system parameters available for improved understandability of an audio stream.

According to another example embodiment, the processing system above includes one of the devices above and a user selected smartphone, tablet device, or media playback device providing a human interface for modification and viewing of system parameters available for selecting one of a plurality of available audio signal streams.

According to another example embodiment, the processing system above includes a manufacturer included smartphone, tablet device, or media playback device providing a human interface for modification and viewing of system parameters available for selecting one of a plurality of available audio streams.

According to another example embodiment, the processing system above includes a user selected smartphone, tablet device, or media playback device providing a human interface for modification and viewing of system parameters available for selecting a combination of multiple available audio streams.

According to another example embodiment, the processing system above includes a manufacturer included smartphone, tablet device, or media playback device providing a human interface for modification and viewing of system parameters available for selecting a combination of multiple of available audio streams.

According to another example embodiment, the processing system includes a user selected smartphone, tablet device, or media playback device directing the processed audio stream to a earphone, headset, or headphone operably coupled to the smartphone or media playback device.

According to another example embodiment, the processing system includes a manufacturer included smartphone, tablet device, or media playback device directing the processed audio stream to the earphone, headset, or headphone operably coupled to the smartphone or media playback device.

According to another example embodiment, the processing system includes a user selected smartphone, tablet device, or media playback device directing the processed audio stream to the earphone, headset or headphone connected directly to the smartphone.

According to another example embodiment, the processing system includes a manufacturer included smartphone, tablet device, or media playback device directing the processed audio stream to the earphone, headset or headphone connected directly to the smartphone or media playback device.

According to another example embodiment, the processing system includes a user selected smartphone, tablet device, or media playback device directing the processed audio stream to the earphone, headset or headphone connected directly to the device.

According to another example embodiment, the processing system includes a user selected smartphone, tablet device, or media playback device directing the processed audio stream to the headset operably coupled to the device.

According to another example embodiment, the processing system includes a user selected smartphone, tablet device, or media playback device providing the human interface for selecting from a plurality of settings selections that have been chosen to provide optimum understandability for given audio conditions and source selections.

According to another example embodiment, the processing system includes a manufacturer included smartphone, tablet device, or media playback device providing the human interface for selecting from a plurality of settings selections that have been chosen to provide optimum understandability for given audio conditions and source selections.

According to another example embodiment, the processing system includes a user selected smartphone, tablet device, or media playback device providing digital signal processing on the audio stream(s) presented such that the understandability of the original source material is enhanced and/or improved.

According to another example embodiment, the processing system includes a manufacturer included smartphone, tablet device, or media playback device providing digital signal processing on the audio stream(s) such that the understandability of the original source material is enhanced and/or improved.

According to another example embodiment, the processing system includes a user selected smartphone, tablet device, or media playback device providing digital signal processing on the audio stream(s) such that the combination of processed source material and locally captured audio information are presented to the user in such a fashion as to maximize fidelity and understandability.

According to another example embodiment, the processing system includes a manufacturer included smartphone, tablet device, or media playback device providing digital signal processing on the audio stream(s) presented such that the combination of processed source material and locally captured audio information are presented to the user in such a fashion as to maximize fidelity and understandability.

According to another example embodiment, the processing system includes a user selected smartphone, tablet device, or media playback device providing enhanced digital content from a local or remote network source in combination with analog or digital source material from one or more sources including but not limited to an optional inductive loop receiver, an optional low power FM receiver, an optional infrared receiver, an optional digital radio transceiver, or one or more optional audio transducer(s) or microphone(s).

According to another example embodiment, the processing system includes a manufacturer included smartphone, tablet device, or media playback device providing enhanced digital content from a local or remote network source in combination with analog or digital source material from one or more sources including but not limited to an optional inductive loop receiver, an optional low power FM receiver, an optional infrared receiver, an optional digital radio transceiver, or one or more optional audio transducer(s) or microphone(s).

### BRIEF DESCRIPTION OF THE DRAWINGS

FIG. 1 depicts a prior art general purpose Assisted Listening Device that operates with a single audio input signal source and has a very simple user interface;

FIG. 2 depicts a prior art hearing aid that operates with a single audio input signal source and has a very simple user interface; and

FIG. 3 is a simplified system diagram indicating the general components according to an example embodiment of the invention including a smartphone, or tablet device that provides a user interface for selecting from a multitude of available audio signal input sources and customizing parameters for the optimization of the end user's listening experience.

### DETAILED DESCRIPTION

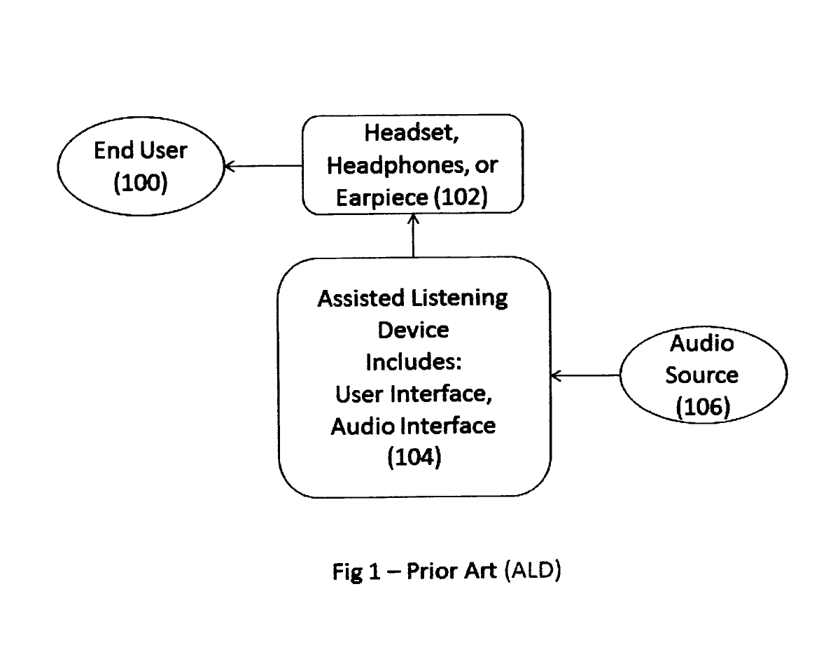

Referring to FIG. 1, an end user 100 may use headphones 102 coupled to prior art general purpose Assisted Listening Device 104 provides amplification of single audio source 106 via headphones 102 to end user 100. Prior art general purpose devices such as Assisted Listening Device 104 normally have a simple user interface consisting of simple hardware controls for channel selection (when applicable) and volume. Generally, no other adjustment controls are provided.

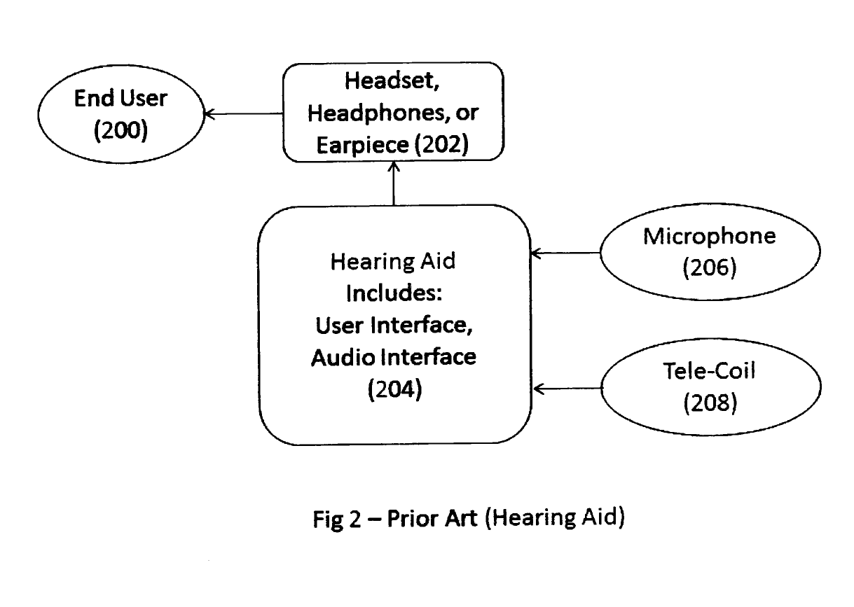

Referring to FIG. 2, an end user 200 may use headphones 202 coupled to prior art Hearing Aid 204 to provide amplification of sounds sensed by local microphone 206 or T-Coil 208 via earpiece 202 to end user 200. Prior art hearing aids 204 normally have a simple user interface consisting of simple hardware controls for volume, a preconfigured processing profile (or none at all) and selection of the microphone or T-Coil (when applicable). Generally, all other adjustments are made by an audiologist, and no additional user controls or adjustments are provided.

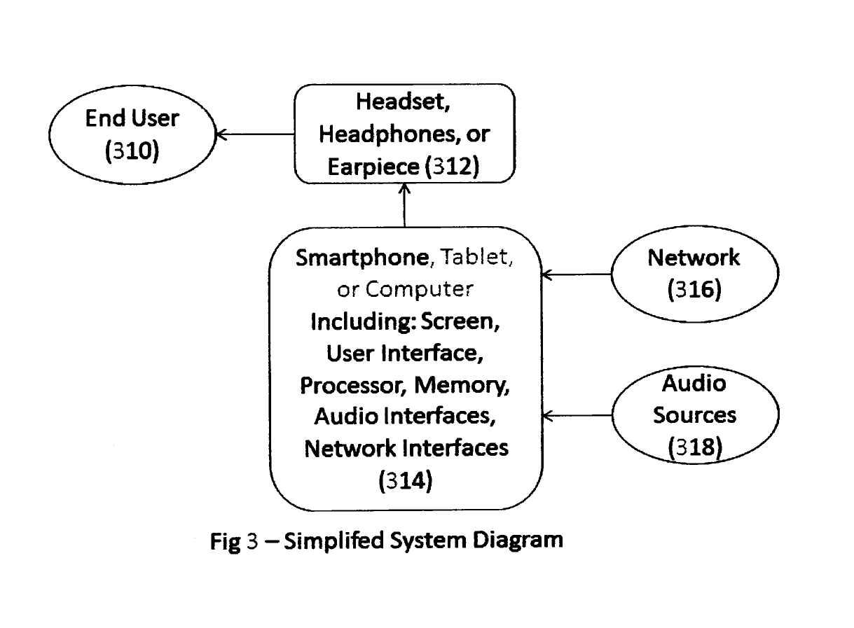

Referring to FIG. 3, a smartphone, tablet device, or computer 314 according to an example embodiment of the invention provides a user interface for selection of audio source 318 and associated parameters, amplification and processing of the chosen audio source(s) 318, and delivery via wired or wireless headphones, earpiece, or headset 312 to the end user 310. Because of the enhanced user interface provided by the smartphone, one or more audio sources 318 can be chosen and enhanced with additional content or audio sources from the network 316. Also because of the enhanced user interface, the user is able to select from multiple audio processing algorithms, modify algorithm parameters, and change processing options as desired to increase understandability in real-time.

The invention permits end user 310 to adjust sound reproduction to specific needs and desires. For example end user 310 may select frequency bands to amplify selectively while minimizing amplification of other frequency bands, much in the same manner as a graphic equalizer. Digital signal processing may be utilized for example, to filter out background noise, such as impulse noise which arises from a bang or pop. These impulse noise events can result from a dropping of a fork or plate in a restaurant, or the slamming of a door in a house. In addition, digital signal processing may be used to reduce echoes by identifying lower amplitude copies of recently received information and choosing not to amplify the copies or other similar sonic artifacts. Digital signal processing may be used to reduce background noise by setting a threshold below which no amplification is applied to the incoming sounds. These types of processing and any other digital signal processing of a sort known to those of ordinary skill in the art may be utilized in the invention as well.

As used in the specification and claims herein, a handheld media unit is considered to include but not be limited to a smartphone, a tablet device, or media playback device.

According to one embodiment of the invention, an audio processing device, includes at least two non-acoustic audio signal input receivers wherein audio signals are received from at least two audio input sources; a processor operably coupled to the at least two audio signal input receivers; the processor being programmed with an algorithm that facilitates selection of one or more inputs of the at least two non-acoustic audio signal input receivers and selection of adjusting parameters for improvement in sound quality and understandability for the end user; a system memory operably coupled to the processor; a two way communication module operably coupleable to a handheld media unit having a video screen interface that receives input from the end user to adjust the parameters for improvement in sound quality and understandability and communicates end user input to the processor; and a local headphone connection whereby audible acoustic signals derived from the audio signals are presented to a listener.

According to another aspect the audio processing device further includes a digital network content source.

According to another aspect the further includes an acoustic transducer or microphone wherein local acoustic signals are received.

According to another aspect, the least two non acoustic audio signal input receivers are selected from a group consisting of an inductive loop receiver, an infrared receiver, a low power FM broadcast receiver, a digital radio transceiver, digital network content source receiver and a local network audio stream transmission.

According to another embodiment of the invention, the operable two way coupling to the handheld media unit includes a radio transceiver.

According to another aspect, the audio processing device further includes a source of additional content that is presentable in the form of the audible acoustic signals or visually via the video screen interface of the handheld media unit.

According to another embodiment of the invention, the audio processing device is physically incorporated within the handheld media unit.

According to another aspect, the audio processing device is physically separate from the handheld media unit and communicatively coupled to the handheld media unit in two way communication with the handheld media unit via the two way communication module.

According to another aspect the processor is further programmed with a digital signal processing algorithm.

The digital signal processing algorithm may function to filter out background noise. The digital signal processing algorithm may function to filter out impulse noise. The digital signal processing algorithm may function to reduce echoes. The digital signal processing algorithm may also function to reduce background noise.

According to another embodiment of the invention, a system for audio processing includes an audio processing device, and a handheld media unit having a video screen interface; the audio processing device includes at least two non-acoustic audio signal input receivers wherein audio signals are received from at least two audio input sources. A processor is operably coupled to the at least two audio signal input receivers. The processor is programmed with an algorithm that facilitates selection of one or more inputs of the at least two non-acoustic audio signal input receivers and adjusting parameters for improvement in sound quality and understandability for the end user. A system memory is operably coupled to the processor and a two way communication module is operably coupleable to the handheld media unit; and a local headphone connection whereby audible acoustic signals derived from the audio signals are presented to a listener. The hand held media unit receives input from the end user to adjust the parameters for improvement in sound quality and understandability and communicating end user input to the processor via the two way communication module.

In another embodiment the device includes a digital network content source.

According to another aspect, the audio processing device further includes an audio transducer or microphone wherein local acoustic signals are received.

According to another aspect, the least two non acoustic audio signal input receivers are selected from a group consisting of an inductive lop receiver, an infrared receiver, a low power FM broadcast receiver, a digital radio transceiver, digital network content source receiver and a local network audio stream transmission.

According to another aspect, operable two way coupling to the handheld media unit comprises a radio transceiver.

According to another embodiment the audio processing device further includes a source of additional content that is presentable in the form of the audible acoustic signals or visually via the video screen interface of the handheld media unit.

According to another embodiment, the audio processing device is physically incorporated within the handheld media unit.

According to another embodiment, the audio processing device is physically separate from the handheld media unit and operably coupled to the handheld media unit in two way communication with the handheld media unit via the two way communication module.

According to another aspect, the processor is further programmed with a digital signal processing algorithm. The digital signal processing algorithm may function to filter out background noise. The digital signal processing algorithm may function to filter out impulse noise. The digital signal processing algorithm may function to reduce echoes. The digital signal processing algorithm may function to reduce background noise.

The invention may be embodied in other specific forms without departing from the spirit of the essential attributes thereof, therefore, the illustrated embodiments should be considered in all respects as illustrative and not restrictive, reference being made to the appended claims rather than to the forgoing description to indicate the scope of the invention.

1. An audio processing device, comprising:
at least two non-acoustic audio signal input receivers wherein audio signals are received from at least two audio input sources;
a processor operably coupled to the at least two audio signal input receivers;
the processor being programmed with an algorithm that facilitates selection of one or more inputs of the at least two non-acoustic audio signal input receivers and selection of adjusting parameters for improvement in sound quality and understandability for the end user;
a system memory operably coupled to the processor;
a two way communication module operably coupleable to a handheld media unit having a video screen interface that receives input from the end user to adjust the parameters for improvement in sound quality and understandability and communicates end user input to the processor; and
a local headphone connection whereby audible acoustic signals derived from the audio signals are presented to a listener.

2. The audio processing device as claimed in claim 1, further comprising a digital network content source.

3. The audio processing device as claimed in claim 1, further comprising an acoustic transducer or microphone wherein local acoustic signals are received.

4. The audio processing device as claimed in claim 1, wherein the least two non acoustic audio signal input receivers are selected from a group consisting of an inductive loop receiver, an infrared receiver, a low power FM broadcast receiver, a digital radio transceiver, digital network content source receiver and a local network audio stream transmission.

5. The audio processing device as claimed in claim 1, wherein the operable two way coupling to the handheld media unit comprises a radio transceiver.

6. The audio processing device as claimed in claim 1, further comprising a source of additional content that is presentable in the form of the audible acoustic signals or visually via the video screen interface of the handheld media unit.

7. The audio processing device as claimed in claim 1, wherein the audio processing device is physically incorporated within the handheld media unit.

8. The audio processing device as claimed in claim 1, wherein the audio processing device is physically separate from the handheld media unit and communicatively coupled to the handheld media unit in two way communication with the handheld media unit via the two way communication module.

9. The audio processing device as claimed in claim 1, wherein the processor is further programmed with a digital signal processing algorithm.

10. The audio processing device as claimed in claim 9, wherein the digital signal processing algorithm functions to filter out background noise.

11. The audio processing device as claimed in claim 9, wherein the digital signal processing algorithm functions to filter out impulse noise.

12. The audio processing device as claimed in claim 9, wherein the digital signal processing algorithm functions to reduce echoes.

13. The audio processing device as claimed in claim 9, wherein the digital signal processing algorithm functions to reduce background noise.

14. A system for audio processing, comprising:
an audio processing device and a handheld media unit having a video screen interface;
the audio processing device including
at least two non-acoustic audio signal input receivers wherein audio signals are received from at least two audio input sources;
a processor operably coupled to the at least two audio signal input receivers;
the processor being programmed with an algorithm that facilitates selection of one or more inputs of the at least two non-acoustic audio signal input receivers and adjusting parameters for improvement in sound quality and understandability for the end user;
a system memory operably coupled to the processor;
a two way communication module operably coupleable to the handheld media unit; and
a local headphone connection whereby audible acoustic signals derived from the audio signals are presented to a listener;
the hand held media unit receiving input from the end user to adjust the parameters for improvement in sound quality and understandability and communicating end user input to the processor via the two way communication module.

15. The audio processing device as claimed in claim 14, further comprising a digital network content source.

16. The audio processing device as claimed in claim 14, further comprising an audio transducer or microphone wherein local acoustic signals are received.

17. The audio processing device as claimed in claim 14, wherein the least two non acoustic audio signal input receivers are selected from a group consisting of an inductive lop receiver, an infrared receiver, a low power FM broadcast receiver, a digital radio transceiver, digital network content source receiver and a local network audio stream transmission.

18. The audio processing device as claimed in claim 14, wherein the operable two way coupling to the handheld media unit comprises a radio transceiver.

19. The audio processing device as claimed in claim 14, further comprising a source of additional content that is presentable in the form of the audible acoustic signals or visually via the video screen interface of the handheld media unit.

20. The audio processing device as claimed in claim 14, wherein the audio processing device is physically incorporated within the handheld media unit.

21. The audio processing device as claimed in claim 14, wherein the audio processing device is physically separate from the handheld media unit and operably coupled to the handheld media unit in two way communication with the handheld media unit via the two way communication module.

22. The audio processing device as claimed in claim 14, wherein the processor is further programmed with a digital signal processing algorithm.

23. The audio processing device as claimed in claim 23, wherein the digital signal processing algorithm functions to filter out background noise.

24. The audio processing device as claimed in claim 23, wherein the digital signal processing algorithm functions to filter out impulse noise.

25. The audio processing device as claimed in claim 23, wherein the digital signal processing algorithm functions to reduce echoes.

26. The audio processing device as claimed in claim 23, wherein the digital signal processing algorithm functions to reduce background noise.
